(19) United States
(12) Patent Application Publication
(10) Pub. No.: US 2013/0204451 A1
(43) Pub. Date: Aug. 8, 2013

(54) CONTROLLING AN ELECTRICAL ENERGY SUPPLY NETWORK

(71) Applicant: Samuel Thomas Staehle, Kamp-Lintfort (DE)

(72) Inventor: Samuel Thomas Staehle, Kamp-Lintfort (DE)

(73) Assignee: SIEMENS AKTIENGESELLSCHAFT, Muenchen (DE)

(21) Appl. No.: 13/879,450

(22) PCT Filed: Oct. 13, 2010
(86) PCT No.: PCT/EP2010/065302

§ 371 Date: Apr. 15, 2013

(51) Int. Cl. G06F 1/26

(52) U.S. Cl. CPC G06F 1/26
USPC 700/291

(57) ABSTRACT

A method controls an energy supply network supplying electrical loads and into which decentralized energy generators feed. The produced energy amounts depend on a current weather situation around the decentralized energy generators. To increase the stability of voltage, a mathematical network model is provided. The network model specifies a relationship between a current weather situation around the energy generator and the electrical energy produced. Weather prediction data specifying an expected future weather situation for the energy generator is determined from weather data specifying a current weather situation in the local region of the energy generator, and an expected future feed-in of electrical energy by the energy generator is determined. Control signals are generated by a control device for stabilizing a voltage level in network sections in which an expected future feed-in has been determined that will lead to a significant deviation of the voltage level from a desired voltage level.

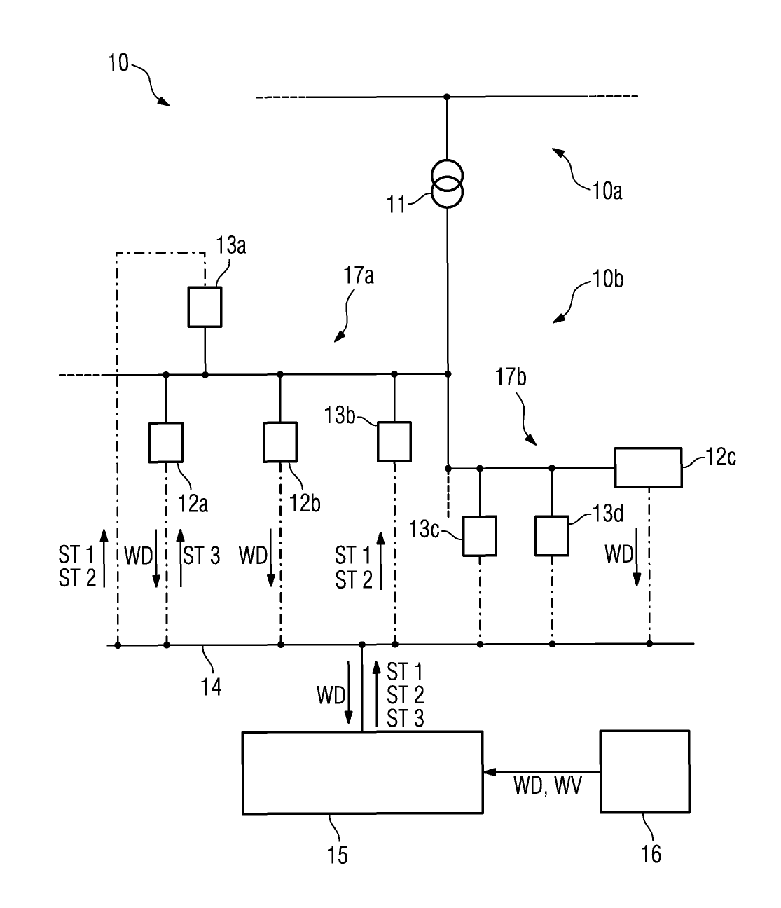

The invention relates to a method for controlling an electrical energy supply network, from which final electrical loads are supplied with electrical energy and into which decentralized energy generators feed electrical energy, the produced energy amount of which depends on a current weather situation in the local region of the particular decentralized energy generator. The invention also relates to a control device for controlling an electrical energy supply network and also to an automation system having a corresponding control device.

Over recent years energy supply networks for transmission and distribution of electrical energy have undergone major changes in respect of their structure. While in classically-constructed energy supply networks energy has been transmitted from few central large-scale generators to a plurality of electrical final loads and thus the direction of transmission runs essentially from the large-scale generators (as the source) to the individual final loads (as sinks), in the more recent past efforts made to liberalize energy markets have led to the emergence of a plurality of energy generators that are smaller and are distributed decentrally in the energy supply network, that feed their electrical energy into the energy supply network. Such decentralized small generators typically involve what are referred to as regenerative energy generators, i.e. energy generators that provide electrical energy from short-term renewable energy sources, such as e.g. wind or sunshine. Such energy generators can be wind power systems or photovoltaic systems for example.

The plurality of existing decentralized energy generators presents new challenges to existing energy automation systems for controlling electrical energy supply networks, since many of the central regulation approaches previously used for classical energy supply networks are no longer suitable for control of an energy supply network having many decentralized energy generators.

While even in classical energy supply networks a difficulty arises in supplying the demand by the energy consumers for electrical energy which varies over time, in energy supply networks with decentralized energy generators there are also problems in respect of the heavily fluctuating provision of electrical energy by the decentralized energy generators, which depends for example on the presence of primary energy sources which are not able to be controlled (such as wind or sunshine for example).

With photovoltaic systems the amount of electrical energy generated depends on the current sunshine above the systems concerned. In concrete terms this means that such systems, when sunshine is especially strong—e.g. with a cloudless sky—generate an especially large amount of energy, while with weak sunshine—e.g. if heavy cloud suddenly occurs—the amount of the electrical energy generated falls markedly. A corresponding behavior is to be observed with wind energy generators in relation to the current wind speed, with which the amount of electrical energy generated correlates.

The consequence of this direct dependence of the energy generated on the current weather conditions in the local region of the particular energy generator is a strong fluctuation of the amount of electrical energy fed into the energy supply network.

Since photovoltaic systems are typically installed in low-voltage parts of the energy supply networks and wind power systems also feed ever more frequently into the low voltage power grid in some cases, very strong fluctuations of the feeding of the regeneratively generated electrical energy into the low voltage parts of the energy supply networks occur, from which likewise the majority of the electrical final loads are supplied with electrical energy. Fluctuations caused by variations in the energy feed are also to be observed in medium voltage parts of energy supply networks.

In technical terms this can have an effect through sudden excesses or also sudden collapses in the voltage level on the individual sections of the energy supply network. While an increased feed can lead to an increase in the voltage level in the network section, a reduced feed may possibly lead to a falling voltage level. On the one hand the result of this is a fluctuating quality of energy supply to the end consumers, but it may also pose a risk of technical outages of devices and systems of the customers of the supply network operator because of violations of the prespecified voltage band, such as is defined in Europe for example in Standard EN50160. In addition it can also occur that a decentralized energy generator, e.g. a photovoltaic system, automatically switches off if a voltage defined as a maximum is exceeded on its network section, and its owner can thus no longer feed energy into the network, with the concomitant losses in income.

The underlying object of the invention is thus to increase the stability of an electrical energy supply network, into which such decentralized energy generators feed electrical energy, of which the amount of energy generated depends on a current weather situation in the local region of the particular decentralized energy generator.

To achieve this object a method for controlling an electrical energy supply network is proposed from which final electrical loads are supplied with the electrical energy and into which such decentralized energy generators feed electrical energy, of which the generated amount of energy depends on a current weather situation in the local region of the particular decentralized energy generator, in which a mathematical network model is provided in a control device of an automation system of the electrical energy supply network, which specifies a relationship between a current weather situation in the local region of the particular decentralized energy generator and the electrical energy is fed by the particular decentralized energy generator into individual sections of the electrical energy supply network. Weather data which specifies a current weather situation in the local region of the particular decentralized energy generator is transferred to the control device. Weather prediction data is determined from the weather data by means of the control device, which specifies an expected future weather situation in the region of the particular decentralized energy generator and an expected future feed of electrical energy on the part of the particular decentralized energy generator into the energy supply network is determined from the weather prediction data by means of the control device using the network model. Control signals are generated by means of the control device which are used to stabilize a voltage level in such sections of the energy supply network in which, using the results of the network model, an expected future feed of electrical energy has been determined, which leads to a deviation which exceeds a deviation threshold value of the voltage level in the particular section from a predetermined nominal voltage level.

The particular advantage of the inventive method lies in the fact that it makes possible a predictive control of individual sections of the energy supply network, in that the effects of a future expected weather situation in the local region of decentralized energy generators on their feeding of electrical energy is considered and in those sections in which a marked change or voltage level is to be expected from a changed feed situation, control actions in the form of currently effective control signals and/or such signals directed towards the near future are used for stabilization of the voltage level. On the one hand the quality of the electrical energy in the network sections concerned is improved by this, since even with sudden changes to the energy feed in such sections, strong fluctuations of the voltage no longer occur, and on the other hand unwanted outages of undersupplied end devices at a low voltage level can be avoided. A predictive control means in this case that the particular weather situation in the near future, i.e. for example a time range of up to 1 hour into the future, must be considered for derivation of the control actions.

In concrete terms there can be provision made for control such that, in the event of a fall of the voltage level in this section being specified by the determined future feeding of electrical energy into a section of the energy supply network, the control signals of selected final electrical loads which are fed by the section concerned will be switched off.

This enables the voltage level of the network section concerned to already be stabilized predictively, since by explicitly switching off electrical loads, reaction is possible to an expected lower feed-in of electrical power in the network section. Also by switching off selected loads an undesired disruption or shutdown of sensitive electrical loads can be avoided. Suitable for temporary electrical shutdown are final electrical loads with storage functionality, such as for example refrigerators and freezers, air-conditioning systems, water heaters or also charging stations for electric vehicles, in which the vehicle battery can be seen as an energy store. In addition such selected end-users can also be those devices that do not necessarily have to be operating at that time, e.g. individual lighting elements of a larger lighting system. In individual cases there can be agreements with the customers of an operator of an energy supply network as to which individual devices can be switched off if necessary by the network operator. For this purpose such devices must have a corresponding controller available which is configured for receiving and for implementing the control signals (e.g. control signals in accordance with broadcast control technology) sent out by the control device of the automation system.

There can also be provision, in the event of the determined future feed-in of electrical energy into a section of the energy supply network specifying an increase in the voltage level in this section, for the control signals of selected final electrical loads which are fed by the section concerned to switch on and/or for selected decentralized energy generators which feed into the relevant section to switch off.

This enables an excessive voltage level to be avoided, since through the explicit switching in of electrical end-users with increased feed-in, the demand for electrical energy is also increased or—if it is not possible to switch in a further end loads or if this would not be sufficient—by explicitly switching off selected decentralized energy generators increased feed into the relevant network section is prevented. Such an explicit switching off also offers the advantage of being able to carry out a balanced and thus fairer distribution of the switch-off times across all energy generators in a network section and thus also of distributing the drop in income associated with the switch-off equally between the individual operators.

In accordance with a further advantageous embodiment of the inventive method there can be provision for the weather data to be recorded by means of measurement devices at the particular decentralized energy generators and/or to be provided by a central weather database and transferred to the control device.

In this way the control device can constantly be provided with up-to-date weather data. Since at some decentralized energy generators (e.g. wind power systems) measuring devices are present in any event for recording weather-related measurement variables, the corresponding measured values can be easily transmitted to the control device as weather data. As an alternative or in addition, weather data can also be obtained for the locations of the decentralized energy generators from weather databases (e.g. the German weather service). For this the precise geographical location of the decentralized energy generator must be recorded once and stored in the control device.

A further advantageous embodiment of the inventive method also makes provision for the determination of the expected future weather situation in the local region of the particular decentralized energy generator to be undertaken using a pattern recognition method which carries out a comparison of the current weather data with historical weather data stored in the control device and establishes from said data a probable development of the weather situation in the local region of the particular decentralized energy generator by determining the weather prediction data.

In such cases for example similarities or regular repetitions of established sequences of the current weather data can be detected by comparison with sequences of previously stored historical weather data, so that weather prediction data, which specifies a probable future sequence of the weather situation in the local regions of the particular decentralized energy generators, can be deduced from said data.

In addition, with suitable weather data detection—e.g. by means of cameras—cloud patterns and cloud information can also be detected, which in their form largely move consistently over the surface of the earth and darken said surface in such cases. With the assistance of pattern detection algorithms even individual cloud fields could be detected in their form and predicted in their direction and speed of movement.

In addition, in accordance with a further advantageous embodiment of the inventive method, there can be provision for the control device also to be supplied from a weather database with weather forecasting data which specifies a future weather situation in the local region of the particular decentralized energy generator, and for the determination of the weather prediction data to also be undertaken using the weather forecasting data.

In this case the weather forecasting data can be used to reinforce the weather prediction data determined by the control device or to allow longer-term tendencies in the development of the particular weather situation to be included in the determination of the weather prediction data.

In concrete terms, in respect of the assessment of the weather situation in the local regions of the particular decentralized energy generators, there can be provision for the weather prediction data to comprise information about at least one of the following values: Cloud cover, sunshine, wind strength, wind direction, current widths of fluctuation of the wind strength (almost a “gustiness” of the wind), current level of fluctuation of the sunshine, i.e. for example a completely cloudy or cloudless sky compared to a partly sunny, partly cloudy sky.

This namely means that those values are specified which have a decisive influence on the energy generation of the particular decentralized energy generators.

The above object is also achieved by a control device of an automation system of an electrical energy supply network which is configured to carry out a method in accordance with one of the previously described embodiments.

Finally the above object is also achieved by an automation system with a correspondingly configured control device.

The invention is to be explained below in greater detail on the basis of an exemplary embodiment. To this end the figure shows a schematic view of an electrical energy supply network which is controlled by a control device.

The FIGURE shows a part of an electrical energy supply network 10. The energy supply network has a medium-voltage part 10a (appr. 6-30kV) and a low-voltage part 10b (<1 kV). The two network parts 10a, 10b are connected to one another via a transformer station 11.

Decentralized energy generators 12a, 12b, 12c, which can feed electrical energy into the energy supply network, are provided in the low-voltage part 10b of the energy supply network 10. The decentralized energy generators involved are those for which the amount of energy generated depends on a current weather situation in the local region of the particular decentralized energy generator, especially on local sunlight or local wind strength. In concrete terms the decentralized energy providers 12a, 12b can involve photovoltaic systems which can be installed for example on the roofs of domestic residences and feed their electrical energy into a first section 17a of the energy supply network 10. The decentralized energy generators 12c can also involve a wind power system which feeds it the electrical energy into a second section 17b of the energy supply network 10. Smaller wind power systems are namely also connected ever more frequently directly to the low-voltage part of the energy supply networks for feeding in electrical energy.

In addition final electrical loads are also provided in the lower-voltage part 10b of the energy supply network 10, of which only the final loads 13a, 13b, 13c, 13d are shown by way of example in the figure. In concrete terms the final loads 13a and 13b obtain their electrical energy from the first section 17a of the energy supply network 10, while the final loads 13c and 13d are fed from the second section 17b. In this context both individual electrical appliances, e.g. domestic appliances (washing machines, tumble dryers, refrigerators, freezers), televisions or computers, and also groups of electrical devices (e.g. lighting for an outside area or a stairwell) can be seen as final electrical loads.

Both the decentralized energy generators 12a-c and also the final loads 13a-d are connected via a communication link, which is clearly shown in the figure by way of example as communication bus 14, to a control device 15 of an automation system, not otherwise shown in any greater detail, for control and monitoring of the energy supply network 10. In this case the communication bus 14 can for example be part of an automation bus which serves as a communication link of the individual components of the automation system of the energy supply network 10. The communication bus 14 can for example be embodied as an Ethernet bus, via which data telegrams can be transmitted in accordance with the Standard IEC 61850 applicable to automation systems. The control device 15 can either be formed by a central data processing device or by a system of data processing devices arranged in a distributed system. In addition the control device 15 can optionally also be connected to a weather database 16.

The method of operation for the predictive control of the energy supply network 10 will be presented below:

The control device 15 executes control software during operation, one of the functions of which is to calculate a mathematical network model which specifies a relationship between a current weather situation in the local region of the particular decentralized energy generator and the energy fed by the particular decentralized energy generator into individual sections of the electrical energy supply network. This network model is used to determine an expected future amount of electrical energy fed in for each decentralized energy generator 12a-c. For this purpose the control device 15 is supplied with a weather data WD which specifies the current weather situation in the local region of the particular decentralized energy generator 12a-c. Weather data WD typically comprises, in respect of the photovoltaic systems 12a and 12b, information about cloud cover and/or sunlight as well as, in respect of the wind power system 12c, information about wind strength and/or wind direction. In such cases the weather data WD can be recorded for example by measurements by means of suitable measurement devices which are provided directly at the decentralized energy generators 12a-c. As an alternative or in addition the weather data WD can also be provided by the weather database 16 (e.g. German weather service) and transferred for example via an Internet connection to the control device 15. In this case, for selecting appropriate weather data WD for the particular energy generators 12a-c, knowledge about the precise geographical position of the particular decentralized energy generators 12a-c is necessary which can be determined once for example during commissioning of the particular energy generator 12a-c and can be maintained 15 in the control device.

The weather data WD recorded directly at the decentralized energy generators 12a-c is transmitted for example in the form of data packets via the communication bus 14 to the control device 15. As an alternative the weather data WT can also be transmitted to the control device 15 via any other given wired or wireless communication method.

As well is the current weather data WD, the control device 15 also keeps historical weather data, i.e. weather data which has been transmitted at previous times to the control device 15 and has been stored there in archive storage. The control device 15 now investigates, using pattern recognition methods, the current and the stored historical weather data and, from the comparison of this weather data, derives probable developments of the weather situation at the local regions of the particular decentralized energy generators 12a-c and determines weather prediction data in this way, which specifies an expected future weather situation in the local region of the particular decentralized energy generators 12a-c. This weather prediction data is computed for periods lying in the near future and thus for example covers a time range of a few minutes or up to an hour into the future.

Optionally the more precise determination of the verification of the weather prediction data determined with the pattern recognition method, weather forecasting data WV can also be obtained from the weather database 16 which specifies a development of the weather situation in the region of the particular decentralized energy generators expected by a weather service.

On the basis of the weather prediction data determined the control device 15 specifies using the network model the expected future feed-in amounts of electrical energy which will be fed by the particular decentralized energy generators 12a-c into the particular network sections 17a and 17b. These expected feed-in amounts allow a deduction to be made as to whether stable operation is expected for the particular network section 17a or 17b, in which feed-in and consumption of electrical energy are roughly balanced, or whether an unbalanced operating state is to be expected which would be evident in a marked increase or reduction of the voltage level in the particular network section 17a, 17b, i.e. a deviation of the actual voltage from a predetermined nominal voltage in a section 17a, 17b, which exceeds a specific deviation threshold value. In accordance with the results of the calculation carried out with the network model the control device generates control signals—either directly or indirectly via a network control system connected to the control device (e.g. a SCADA system or a substation-automation system), which are intended to contribute to a stabilization of the voltage level in the particular network sections 17a, 17b.

In such cases, in general terms, for an expected reduction in the feeding-in of electrical energy in a network section 17a or 17b, control signals are created which bring about a reduction of the amount of electrical energy consumed from the network section in question 17a or 17b by the final loads 13a-d. In a corresponding way, for an expected increase in the feeding in of electrical energy into a network section 17a, 17b, control signals are generated which either bring about an increase in the consumption of electrical energy by the final loads 13a-d in the network section 17a, 17b in question or —should this not be possible or not be sufficient—bring about a temporary switching off for throttling of the feeding-in of electrical energy by one or more decentralized energy generators 12a-c. A central control of the switching off or throttling of the feeding-in also enables a most even distribution possible over an observation period (e.g. a year) of such measures to the particular energy generators 12a-c to be achieved, so that where possible no operators of an energy generator are disadvantaged.

The method of operation will be explained once again on the basis of examples: if for example, because of a sudden buildup of thick cloud in the local region of the photovoltaic systems 12a and 12b, a sharp drop of the amounts of electrical energy fed into the first section 17a of the energy supply network 10 is forecast by the control device 15, the control device 15 causes first control signals ST1 to be issued, which bring about a temporary switching off of selected final loads (e.g. the final loads 13a and 13b) in this section 17a. The fact that the reduced feed-in amount is now balanced out by a likewise reduced consumption of electrical energy enables the voltage level in the first section 17a to be held stable. If the feed-in amount then increases again because of increased sunshine, the switched-off final loads 13a, 13b can be switched back on again by means of the second control signals ST2. If the feeding-in increases even further because of further increased sunshine or if a few of the final loads 13a, 13b are switched off by their users, then to avoid a state of imbalance in the first network section 17a, third control signals ST3 can also be created which bring about a switching-off or throttling of selected energy generators, e.g. of the energy generator 12a.

In the described manner an energy supply network into which decentralized energy generators are linked, of which the amount of electrical energy fed in is dependent on a current weather situation, can be controlled in a predictive stable manner, in particular the voltage stability in the individual sections of the energy supply network can be safeguarded.

1-9. (canceled)

10. A method for controlling an electrical energy supply network supplying final electrical loads with electrical energy and in which decentralized energy generators feed the electrical energy, a produced energy amount of the decentralized energy generators depends on a current weather situation in a region of a respective decentralized energy generator, which comprises the steps of:
providing a mathematical network model in a control device of an automation system of the electrical energy supply network, the mathematical network model specifying a relationship between a current weather situation in a local region of the respective decentralized energy generator and the electrical energy fed by the respective decentralized energy generator into individual sections of the electrical supply network;
transferring to the control device weather data specifying the current weather situation in the local region of the respective decentralized energy generator;
establishing from the weather data by means of the control device weather prediction data specifying an expected future weather situation in the local region of the respective decentralized energy generator;
determining an expected future feeding-in on a part of the respective decentralized energy generator into the electrical energy supply network from the weather prediction data by means of the control device using the mathematical network model; and
creating control signals by means of the control device, the control signals being used for stabilization of a voltage level in the individual sections of the electrical energy supply network, in which, using results of the mathematical network model, the expected future feeding-in of the electrical energy has been established, which leads to a deviation of the voltage level in a respective section from a predetermined nominal voltage level which exceeds a deviation threshold value.

11. The method according to claim 10, which further comprises switching off, via the control signals, selected ones of the final electrical loads which are supplied by the respective section concerned in an event of the determined future feeding-in of the electrical energy into the respective section of the electrical energy supply network specifying a drop in the voltage level in the respective section.

12. The method according to claim 10, wherein in an event of the determined future feeding-in of the electrical energy into the respective section of the electrical energy supply network specifying a rise in the voltage level in the respective section the control signals switch on selected ones of the final electrical loads which are supplied by the respective section concerned, and/or switch off or throttle selected ones of the decentralized energy generators which feed into the respective section.

13. The method according to claim 10, which further comprises performing at least one of:
recording the weather data by measurement devices at the respective decentralized energy generator and is transferred to the control device; or
providing the weather data by a central weather database and is transferred to the control device.

14. The method according to claim 10, which further comprises establishing the expected future weather situation in the local region of the respective decentralized energy generator using pattern recognition methods which perform a comparison of current weather data with historical weather data stored in the control device and determine from this a probable development of the weather situation in the local region of the respective decentralized energy generator by determining weather prediction data.

15. The method according to claim 10, which further comprises supplying weather forecasting data also to the control device from a weather database which specifies a future weather situation in the local region of the respective decentralized energy generators, and the weather prediction data is also determined using the weather forecasting data.

16. The method according to claim 10, wherein the weather prediction data contains information about at least one of the following values:
cloud cover;
sunlight;
fluctuation range of the sunlight;
wind strength;
wind direction; and
fluctuation range of the wind strength.

17. A control device of an automation system of an electrical energy supply network, the control device comprising:
a processor programmed to control the electrical energy supply network supplying final electrical loads with electrical energy and in which decentralized energy generators feed electrical energy, a produced energy amount of the decentralized energy generators depends on a current weather situation in a local region of a respective decentralized energy generator, said processor programmed to:
provide a mathematical network model in a control device of an automation system of the electrical energy supply network, the mathematical network model specifying a relationship between a current weather situation in the local region of the respective decentralized energy generator and the electrical energy fed by the respective decentralized energy generator into individual sections of the electrical supply network;
transfer to the control device weather data specifying the current weather situation in the local region of the respective decentralized energy generator;
establish from the weather data by means of the control device weather prediction data specifying an expected future weather situation in the local region of the respective decentralized energy generator;
determine an expected future feeding-in on a part of the decentralized energy generator into the electrical energy supply network from the weather prediction data by means of the control device using the mathematical network model; and create control signals by means of the control device, the control signals being used for stabilization of a voltage level in the individual sections of the electrical energy supply network, in which, using results of the mathematical network model, the expected future feeding-in of the electrical energy has been established, which leads to a deviation of the voltage level in a respective section from a predetermined nominal voltage level which exceeds a deviation threshold value.

18. An automation system, comprising:
the control device according to claim 17.
